(19) United States
(12) Patent Application Publication
(10) Pub. No.: US 2016/0277791 A1
(43) Pub. Date: Sep. 22, 2016

(54) DISPLAY SYSTEM, AND METHOD OF PLAYING BLUETOOTH AUDIO AND APPARATUS OF DISPLAY SYSTEM

(71) Applicants: BOE TECHNOLOGY GROUP CO., LTD., Beijing (CN); BEIJING BOE VISION-ELECTRONICS TECHNOLOGY CO., LTD., Beijing (CN)

(72) Inventors: Chenbin Fu, Beijing (CN); Shaoan Li, Beijing (CN)

(73) Assignee: BOE Technology Group Co., Ltd., Beijing (CN)

(21) Appl. No.: 14/436,744

(22) PCT Filed: Oct. 27, 2014
(86) PCT No.: PCT/CN2014/089557

§ 371 Date: Apr. 17, 2015

(30) Foreign Application Priority Data
Jul. 21, 2014 (CN) 201410346341.4

(51) Int. Cl. H04N 21/4363; H04N 5/60; H04N 21/438; H04N 21/439

(52) U.S. Cl. CPC H04N 21/43637; H04N 21/43635; H04N 21/439; H04N 5/60; H04N 21/4383; H04N 21/4396

(57) ABSTRACT

The embodiments of the present disclosure disclose a display system, and Bluetooth audio play method and apparatus of the display system. The display system comprises: an image processing system comprising multiple signal input channels configured to process input information from respective interfaces respectively, and output audio information and image information; a display screen configured to output an image according to the received image information; and a Bluetooth processing system configured to switch the image processing system to one of the multiple signal input channels, capture audio information and image information output from the signal input channel to which the image processing system is currently switched, output the image information to the display screen, and convert the audio information into a Bluetooth signal and output the Bluetooth signal. The method according to the is embodiments of the present disclosure enables applying the Bluetooth technology to the display system, especially the smart television, to enable the smart television to use the Bluetooth audio play device.

This application claims priority from CN Patent Application No. 201410346341.4, filed Jul. 21, 2014, which is incorporated herein by reference in its entirety.

### TECHNICAL FIELD

The present disclosure relates generally to smart television technology, and in particular, to a display system, a method of playing Bluetooth audio and an apparatus of the display system.

### BACKGROUND

Smart televisions, as independent display devices, achieve functions of decoding and displaying a variety of audio and video signals conventionally. In a smart television, different audio and video signals are decoded and finally output for display using totally is different signal channels. For example, a conventional smart television may use the following signal channels: Android system, High Definition Multimedia Information (HDMI), analog television, digital television, video, Component, computer, interface such as Universal Serial Bus (USB), or the like.

Bluetooth, as a short-distance wireless information transmission technology, has been widely applied on the smart devices such as mobile phones or the like, and electronic devices such as Bluetooth earphones, Bluetooth loudspeaker boxes or the like have become audio devices which are currently popular. Currently, only applications on an operating system in the smart television support Bluetooth transmission, and other applications which are not on the operating system substantially do not support Bluetooth transmission. Therefore, information in conventional signal channels such as digital television signal, analog television signal, HDMI signal or the like can only be output through an inherent output interface built in the television, and cannot be output through Bluetooth to external devices such as Bluetooth loudspeaker boxes. It will thus be appreciated that it is desired to achieve Bluetooth transmission of information in all signal channels in the smart television.

### SUMMARY

The embodiments of the present disclosure propose a display system, a method of playing Bluetooth audio and an apparatus of the display system, to achieve Bluetooth transmission of signals in all signal input channels in the television.

In an aspect of the embodiments of the present disclosure, a method Bluetooth audio play of a display system is proposed, comprising:

receiving selection information for a signal input channel from a user, and switching an image processing system to a corresponding signal input channel according to the selection information;

capturing audio information and image information output from the corresponding signal input channel;

outputting the image information to a display screen, and

converting the audio information into a Bluetooth signal and outputting the Bluetooth signal.

The method further comprises: before receiving selection information of a signal is input channel from a user,

detecting a Bluetooth connection state, and matching with a Bluetooth audio play device; and

setting an audio play interface built in the display system in a mute state.

In another aspect of the embodiments of the present disclosure, a Bluetooth audio play apparatus of a display system is provided, comprising:

a switching module configured to receive selection information for a signal input channel from a user, and switch an image processing system to a corresponding signal input channel according to the selection information;

a capturing module configured to capture audio information and image information output from the corresponding signal input channel; and

an output module configured to output the image information to a display screen, and convert the audio information into a Bluetooth signal and output the Bluetooth signal.

The Bluetooth audio play apparatus further comprises:

a detection module configured to detect a Bluetooth connection state, and match with a Bluetooth audio play device; and

a muting module configured to set an audio play interface built in the display system in a mute state.

In another aspect of the present disclosure, a display system is provided, comprising:

an image processing system comprising multiple signal input channels configured to process input information from respective interfaces respectively, and output audio information and image information;

a display screen configured to output an image according to the received image information; and

a Bluetooth processing system configured to switch the image processing system to one of the multiple signal input channels, capture audio information and image information output from the signal input channel to which the image processing system is currently switched, output the image information to the display screen, and convert the audio information into a Bluetooth signal and output the Bluetooth signal.

Preferably, the multiple signal input channels comprise an input interface, a processing unit and an output interface, and the processing unit comprises an audio and video decoder.

Preferably, the Bluetooth processing system comprises:

a processor configured to switch the image processing system to one of the multiple signal input channels, capture audio information and image information output from the signal input channel to which the image processing system is currently switched, output the image information to the display screen, and output the audio information to a Bluetooth processing chip; and

the Bluetooth processing chip configured to convert the audio information into a Bluetooth signal and output the Bluetooth signal.

Preferably, the processor comprises a single-core or multi-core processor on which an operating system operates.

The display system further comprises:

a Bluetooth audio play device configured to receive the Bluetooth signal and play a sound signal according to the Bluetooth signal.

Preferably, the image information is directly output by the Bluetooth processing system to the display screen, or is processed and then output by the Bluetooth processing system to the display screen.

### BRIEF DESCRIPTION OF THE DRAWINGS

FIG. 1 is a structural diagram of a smart television according to an embodiment of the present disclosure; and

FIG. 2 is a flowchart of a Bluetooth audio play method of a smart television according to an embodiment of the present disclosure.

### DETAILED DESCRIPTION OF THE EMBODIMENTS

In order to make the purposes, technical solutions, and advantages of the embodiments of the present disclosure more clear and obvious, the present disclosure will be further described in detail below in conjunction with specific embodiments and is with reference to accompanying drawings.

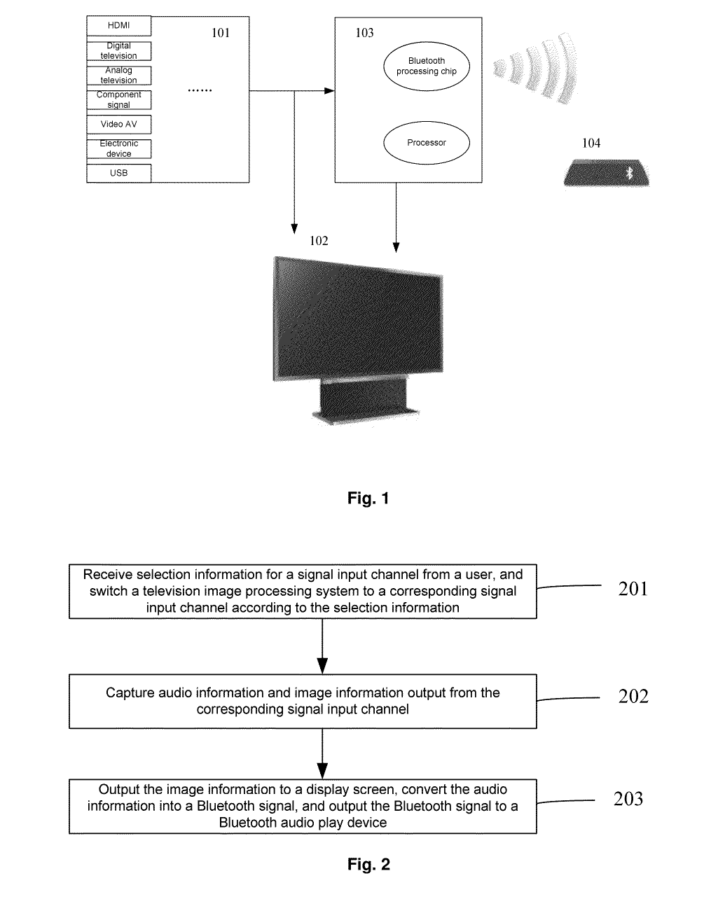

FIG. 1 illustrates a structural diagram of a smart television according to an embodiment of the present disclosure. As shown in FIG. 1, the smart television according to an embodiment of the present disclosure may comprise:

a television image processing system 101 comprising multiple signal input channels configured to process input information from respective interfaces respectively, and output at least audio information and image information;

a display screen 102 configured to output an image according to the image information received from the television image processing system 101;

a Bluetooth processing system 103 configured to control the television image processing system 101 to switch to one of the multiple signal input channels according to a user's selection, capture audio information and image information output from the signal input channel to which the television image processing system 101 is currently switched, output the image information to the display screen, and convert the audio information into a Bluetooth signal and output the Bluetooth signal to a Bluetooth audio play device 104; and

the Bluetooth audio play device 104 configured to output a sound according to the Bluetooth signal received from the Bluetooth processing system 103.

The above smart television system according to an embodiment of the present disclosure can play audio signals of all signal channels in the smart television through an external Bluetooth loudspeaker box, without any audio connection cable, so as to achieve wireless reception of audio information output from the television by a loudspeaker box in any indoor place.

Structures and functions of different constituent components of the smart television system will be described in detail below according to specific implementations.

The television image processing system 101 in the smart television system according to an embodiment of the present disclosure may comprise one or more signal input channels, such as an HDMI signal input channel, an analog television signal input channel (which receives information from a RF interface), a digital television signal input channel (which receives information from a RF interface), a video signal input channel is (which receives information from an AV interface), a Component signal input channel (which receives information from YPbPr), an electronic device signal input channel (which receives information from a VGA interface) and a USB signal input channel. Each signal input channel comprises an information input interface, an information output interface, and an information processing unit. The information processing unit is configured to decode or additionally process the input information input from a corresponding input interface, and output the acquired image information and audio information from a corresponding output interface.

The multiple signal input channels comprise respective input interfaces, output interfaces, and processing units. The processing unit is configured to process information input from the input interface, and output the processed information from the output interface in a form of audio information and image information. The processing unit may be an audio/video decoder or another processing unit for correspondingly decoding or additionally processing the audio and video in the input information.

The HDMI signal input channel is configured to receive a high definition video signal, for example, from a set top box, a DVD, or another electronic device, process, such as decode the received high definition video signal, and output the acquired image information and audio information respectively.

The digital television signal input channel is configured to receive a DTMB digital television signal from a set top box, decode and additionally process the received DTMB digital television signal, and output the acquired image information and audio information respectively.

The USB signal input channel is configured to receive input information from the USB device, decode or additionally process the received input information, and output the acquired image information and audio information respectively.

The electronic device signal input channel is configured to be connected to an electronic device with a VGA interface such as a computer, to directly output the received VGA signal. That is, in such interface mode, the display screen of the television may be used as a display of an electronic device such as a computer, and the player of the television is used as a player of the electronic device.

The video signal input channel is configured to receive a video signal output by a video device such as a set top box, a DVD or the like, process, for example, decode the received video signal, and then output the acquired image information and audio information respectively.

The Component signal input channel is configured to receive a Component signal output by a video device such as a set top box, a DVD or the like, process, for example, decode the received Component signal, and then output the acquired image information and audio information respectively.

The analog television signal channel is configured to receive an analog television signal input through a RF interface (i.e., an analog television signal input through a wired television line), process, for example, decode the received analog television signal, and then output the acquired image information and audio information respectively.

Of course, the signal input channel of the smart television system according to an embodiment of the present disclosure is not limited to the examples described above, and may further comprise any other television signal channel, which is not limited here.

The smart television according to an embodiment of the present disclosure further comprises a Bluetooth processing system 103, which may comprise a processor and a Bluetooth processing chip.

Alternatively, the processor may comprise a single-core or multi-core processor, such as a single-core processor, a dual-core processor, or a quad-core processor, on which an embedded operating system may be operated. The processor is configured to capture audio information and/or image information output from a corresponding signal input channel in the television image processing system 101, output the captured audio information to the Bluetooth processing chip, and output the captured image information to the display screen.

The Bluetooth processing chip converts the audio information received from the processor into a Bluetooth signal based on a Bluetooth standard, and outputs the Bluetooth signal to the Bluetooth audio player. A conventional Bluetooth processing chip may be used as the Bluetooth processing chip here, such as a Bluetooth processing is chip of a RTL8723AS model from RealTek, which can support a Bluetooth 3.0 protocol.

The Bluetooth processing system 103 may directly output the captured image information to the display screen 102, or process the captured image information and then output it to the display screen 102. For example, the image information may be embedded in a small window of the user interaction interface for display, and at the same time, other information is further displayed on the user interaction interface, such as a switch and a selection key for a signal input channel, or the like.

Alternatively, the embedded operating system may comprise operating systems such as Android, iPhone OS, Mac OS, Windows Mobile or Symbian or the like.

Specifically, the specific function of the Bluetooth processing system 103 will be described below.

A user interacts with the operating system which runs on the processor in the Bluetooth processing system 103 through a user interaction interface. For example, the user may select a signal input channel to be received currently through the user interaction interface. For example, if the user wants to view a digital television, the user selects the digital television signal channel, and if the user wants to receive DVD, the user selects a Component signal input channel or the like. The processor receives the selection from the user, controls the television processing system 101 to switch to the signal input channel selected by the user, and receives the corresponding input information through the signal input channel to which the television processing system 101 is switched, correspondingly processes the corresponding input information, and outputs the acquired audio information and image information. The processor captures the audio information and image information output from the signal input channel to which the television processing system 101 is switched, outputs the audio information to the Bluetooth processing chip, and outputs the image information to the display screen for display. The Bluetooth processing chip converts the received audio information into a Bluetooth signal according to the Bluetooth protocol, and outputs it to the Bluetooth play device 104.

Alternatively, the Bluetooth play device 104 may comprise a Bluetooth loudspeaker box, a Bluetooth earphone or the like. The Bluetooth play device 104 receives Bluetooth audio information output by a Bluetooth processing system 103, and plays the received is Bluetooth audio information in a form of sound.

FIG. 2 illustrates a flowchart of a method of playing Bluetooth audio in a smart television according to an embodiment of the present disclosure. The method of playing Bluetooth audio in a smart television according to an embodiment of the present disclosure will be described with reference to FIGS. 1 and 2. As shown in FIG. 2, the method of playing Bluetooth audio in a smart television according to an embodiment of the present disclosure may comprise:

step 201: receiving selection information of a signal input channel from a user, and switching a television image processing system to a corresponding signal input channel according to the selection information;

step 202: capturing audio information and image information output from the corresponding signal input channel; and

step 203: outputting the image information to a display screen, converting the audio information into a Bluetooth signal, and outputting the Bluetooth signal to a Bluetooth audio play device.

Alternatively, the method may further comprise: before step 201,

detecting a Bluetooth connection state, and matching with and connecting to a Bluetooth audio play device; and

setting an audio play interface built in the smart television in a mute state.

With respect to the step of detecting a Bluetooth connection state, in the embodiment of the present disclosure, after being turned on, the smart television firstly monitors a connection state of the Bluetooth audio play device 104. In an initial state, it needs to match with the Bluetooth audio play device 104. For example, the matching information and the user information are input manually. In a case that it is successful to match with the Bluetooth audio play device, the Bluetooth processing system 103 stores the matching information of the Bluetooth audio play device such as a Bluetooth loudspeaker box, including an identity name, user information or the like of the Bluetooth audio play device. Then, whenever the smart television is turned on, the Bluetooth processing system 103 firstly scans the surrounding Bluetooth devices, to search for all Bluetooth devices. Then, information of all scanned Bluetooth devices is is compared with the stored matching information of the Bluetooth audio play device, to determine whether there is a condition that the matching is successful. If there is a Bluetooth device which is matched successfully, the Bluetooth device is connected automatically.

With respect to the step of setting an audio play interface built in the smart television in a mute state, after the smart television is successfully connected to the Bluetooth audio play device 104, by taking an Android system built in the smart television as an example, the Android system firstly processes, for example, mutes the audio play interface (such as an audio power amplifier) on the smart television platform, to turn off the loudspeaker box built in the smart television. Therefore, the audio information output from a corresponding signal input channel in the television image processing system cannot be played through the loudspeaker box built in the smart television, and instead, is played by the Bluetooth audio play device 104.

In step 201, alternatively, the Bluetooth processing system 103 may display a user interaction interface to a user through the display screen 104, and the user may operates the user interaction interface through a remote controller, to select an action to be taken currently, such as viewing a television program or a DVD program or the like. If the user selects to view a digital television program, the Bluetooth processing system 103 controls the television image processing system 101 to switch to a digital television signal input channel. In this case, the digital television signal input channel receives a digital television signal, processes, for example decodes the digital television signal, and outputs the processed audio information and image information.

Specifically, various signal input channels in the television image processing system 101 may be designed as independent signal channel application programs based on an operating system in the Bluetooth processing system 103. In response to the user selecting a corresponding signal input channel, a corresponding signal channel application program is called from the operating system, to switch the television image processing system 101 to the corresponding signal input channel, and the signal input channel to which the television image processing system 101 is switched receives and correspondingly processes the input information.

In step 201, specifically, the signal input channel may be switched in the following manner.

Firstly, functions (for example, an HDMI play function, a digital television play function, an analog television play function, a USB information transmission function, a computer connection function, a Component information function or the like) of various signal input channels of the smart television are encapsulated, to establish a unified signal channel application program interface.

Secondly, a dedicated operating system service program, for example, referred as TvProvider, is established for accessing to the encapsulated signal channel application program interface.

Thirdly, in the operating system interface, a switching application program dedicated for accessing to a signal source is designed, which is referred as ChangeSource, for example. Once a user starts the switching application program through an interaction interface, the switching application program will automatically call the system service program to access to the corresponding signal channel application program interface, which controls the television image processing system 101 to switch to a corresponding signal input channel thereof.

In step 202, the Bluetooth processing system 103 switches the television image processing system 101 to a corresponding signal input channel, then monitors the signal input channel, and captures the audio information and video information output from the signal input channel.

In step 203, the Bluetooth processing system 103 performs Bluetooth protocol conversion on the captured audio information via a Bluetooth processing chip, and outputs the converted Bluetooth signal to the Bluetooth audio play device. In addition, the Bluetooth processing system 103 further processes the captured image information, and then outputs the processed image information to the display screen for display, or directly outputs the captured image information to the display screen for display.

The above input channel switching method will be described below by taking a user playing a high definition video using an HDMI signal channel as an example.

Firstly, the user opens a “signal source switch” menu through an operating system interface, which actually starts a ChangeSource application program. The user selects is and confirms the HDMI signal input channel in the “signal source switch” menu, and in response to this operation, the ChangeSource application program issues to a TvProvider service program a system message for starting the HDMI signal input channel. The TvProvider service program runs in the background after the operating system is started. The TvProvider service program accesses to the signal channel application program interface according to the received system message, and sets a display port to switch to the HDMI signal input channel. Then, the HDMI signal input channel receives the corresponding input information, processes the received corresponding input information, and outputs the processed information. The TvProvider service program captures the output audio information, and invokes a corresponding program (such as a Bluetooth service program) in the system to output the audio information to the Bluetooth processing chip, which converts the audio information into a Bluetooth signal and outputs the Bluetooth signal to an external Bluetooth audio play device.

Similarly, the switching of other signal channels is the same as that of the HDMI. That is, in response to the user confirming the selected channel, the ChangeSource transmits a system message to the TvProvider service program, and the TvProvider service program accesses to a functional application program interface and configures a correct signal channel port, thereby completing the channel switching.

In addition, the present disclosure further provides a Bluetooth audio play apparatus of a smart television, comprising:

a switching module configured to receive selection information of a signal input channel from a user, and switch a television image processing system to a corresponding signal input channel according to the selection information;

a capturing module configured to capture audio information and image information output from the corresponding signal input channel; and

an output module configured to output the image information to a display screen, convert the audio information into a Bluetooth signal, and output the Bluetooth signal to a Bluetooth audio play device.

As the apparatus corresponds to the above Bluetooth audio play method of the smart television, the details may be known with reference to the description of the is method, and will not be described here.

The above technical solutions according to the embodiments of the present disclosure enable applying Bluetooth audio transmission in the smart television system. The Bluetooth processing system controls switching of various signal input channels of the television, monitors the audio information and image information output from the current signal input channel in real time, converts the audio information into a Bluetooth signal based on the Bluetooth protocol, outputs the Bluetooth signal to the Bluetooth device, and at the same time processes and outputs the image information to the display screen, or directly outputs the image information to the display screen. The above technical solutions according to the embodiments of the present disclosure enable wireless transmission of an audio signal of a smart television and enable use of the Bluetooth loudspeaker box of the home theatre in the home environment. Of course, the above solutions proposed in the present disclosure are not only applicable to the smart television system, but also applicable to other similar display systems. The technical solutions according to the embodiments of the present disclosure may be applied to other display systems with various signal channels, and can achieve Bluetooth transmission of signals in all signal channels of the display system by using the operating system supporting Bluetooth transmission in the display system.

The above specific embodiments further describe the purposes, technical solutions and effects of the present disclosure in detail. It should be understood that the above description is merely specific embodiments of the present disclosure, instead of limiting the present disclosure. Any modification, equivalent substitution, improvement etc., made within the spirit and principle of the present disclosure, should be included in the scope of the present disclosure.

What is claimed is:

1. A Bluetooth audio play method of a display system, comprising:
receiving selection information for a signal input channel from a user, and switching an image processing system to a corresponding signal input channel according to the selection information;
capturing audio information and image information output from the corresponding signal input channel;
outputting the image information to a display screen, and
converting the audio information into a Bluetooth signal and outputting the Bluetooth signal.

2. The method according to claim 1, further comprising: before receiving selection information of a signal input channel from a user,
detecting a Bluetooth connection state, and matching with a Bluetooth audio play is device; and
setting an audio play interface built in the display system in a mute state.

3. A Bluetooth audio play apparatus of a display system, comprising:
a switching module configured to receive selection information of a signal input channel from a user, and switch an image processing system to a corresponding signal input channel according to the selection information;
a capturing module configured to capture audio information and image information output from the corresponding signal input channel; and
an output module configured to output the image information to a display screen, and convert the audio information into a Bluetooth signal and output the Bluetooth signal.

4. The apparatus according to claim 3, further comprising:
a detection module configured to detect a Bluetooth connection state, and match with a Bluetooth audio play device; and
a muting module configured to set an audio play interface built in the display system in a mute state.

5. A display system, comprising:
an image processing system comprising multiple signal input channels configured to process input information from respective interfaces respectively, and output audio information and image information;
a display screen configured to output an image according to the received image information; and
a Bluetooth processing system configured to switch the image processing system to one of the multiple signal input channels, capture audio information and image information output from the signal input channel to which the image processing system is currently switched, output the image information to the display screen, and convert the audio information into a Bluetooth signal and output the Bluetooth signal.

6. The display system according to claim 5, wherein the multiple signal input channels comprise an input interface, a processing unit and an output interface, wherein the processing unit comprises an audio and video decoder.

7. The display system according to claim 5, wherein the Bluetooth processing system comprises:
a processor configured to switch the image processing system to one of the multiple signal input channels, capture audio information and image information output from the signal input channel to which the image processing system is currently switched, output the image information to the display screen, and output the audio information to a Bluetooth processing chip; and
the Bluetooth processing chip configured to convert the audio information into a Bluetooth signal and output the Bluetooth signal.

8. The display system according to claim 7, wherein the processor comprises a single-core or multi-core processor on which an operating system runs.

9. The display system according to claim 5, further comprising:
a Bluetooth audio play device configured to receive the Bluetooth signal and play a sound signal according to the Bluetooth signal.

10. The display system according to claim 5, wherein the image information is directly output by the Bluetooth processing system to the display screen, or is processed and then output by the Bluetooth processing system to the display screen.
